(19) United States
(12) Patent Application Publication
(10) Pub. No.: US 2007/0006956 A1
(43) Pub. Date: Jan. 11, 2007

(54) Self-supporting type pneumatic run-flat tire, and insert and bead rubber composition for run-flat capability

(75) Inventors: Jong Bok Park, Daejeon (KR); Doo Young Chang, Daejeon (KR)

Correspondence Address: GREENLEE WINNER AND SULLIVAN P C, 4875 PEARL EAST CIRCLE, SUITE 200, BOULDER, CO, 80301, US

(73) Assignee: HANKOOK TIRE CO. LTD., Seoul (KR)

(21) Appl. No.: 11/425,357

(22) Filed: Jun. 20, 2006

(30) Foreign Application Priority Data
Jul. 7, 2005 (KR) 10-2005-0061090

(51) Int. Cl. B60C 17/00

(52) U.S. Cl. 152/517; 152/555; 152/543

(57) ABSTRACT

A self-supporting type pneumatic run-flat tire is optimized in location and gauge of insert rubber at sidewalls, thereby enhancing run-flat and expansion capabilities. The self-supporting type pneumatic run-flat tire comprises an insert and bead rubber composition which comprises syndiotactic 1,2-polybutadiene in order to enhance run-flat capability.

### CROSS-REFERENCE TO RELATED APPLICATIONS

This application claims priority from Korean Patent Application No. 10-2005-0061090, filed Jul. 7, 2005, which is incorporated herein in its entirety to the extent not inconsistent herewith.

### BACKGROUND OF THE INVENTION

The present invention relates to a self-supporting type pneumatic run-flat tire, which has a structure of radial carcass and is applicable to standards of 60-series or less, and an insert and bead rubber composition for run-flat capability. More particularly, the present invention relates to a self-supporting type pneumatic run-flat tire which is optimized in location and gauge of insert rubber at sidewalls, thereby enhancing run-flat and expansion capabilities, and to an insert and bead rubber composition which comprises syndiotactic 1,2-polybutadiene for run-flat capability.

Various self-supporting type pneumatic run-flat tires have been developed by many tire manufacturers since 1970's. Some of them are disclosed in U.S. Pat. No. 3,949,798 filed in 1974, and assigned to Firestone Tire Rubber Co., and in patents assigned to Dunlop Tire Co. For the self-supporting type pneumatic run-flat tires disclosed in the publication, a run-flat capability can be secured by reinforcing sidewalls with a specific insert rubber, but an expansion capability is deteriorated. In this regard, many manufacturers have developed tires of various structures which can ensure the run-flat capability while preventing the expansion capability from being deteriorated. Some of them are disclosed in Japanese Patent Laid-open Publication Nos. 1998-138720 and 1998-067211 of Bridgestone Corp., U.S. Pat. No. 6,536,494 assigned to Dunlop Tire Co.

On the other hand, an amount of reinforcing filler or vulcanizing agent is increased for the purpose of enhancing rigidity of the sidewalls in the run-flat tire. In this case, since the specific gravity of the reinforcing filler is in the range of 1.8˜2.0, it acts as a main cause of an increase in weight of rubber products, which causes difficulty in weight reduction of the tire, and therefore causes several problems in weight reduction of a vehicle.

Since such conventional self-supporting type pneumatic run-flat tires produced as described above are disadvantageous in terms of fatigue resistance, crack resistance, and exothermic resistance, they fail to maintain requirement for the run-flat capability, leading to splitting of the rubber. In particular, the conventional self-supporting type pneumatic run-flat tires cannot be prevented from being increased in weight due to reinforcement of the insert.

### SUMMARY OF THE INVENTION

The present invention has been made to solve the above problems, and it is an object of the present invention to provide a self-supporting type pneumatic run-flat tire, which comprises an insert rubber so as to be optimized in location and gauge of the insert rubber at sidewalls, thereby enhancing run-flat and expansion capabilities.

It is another object of the present invention to provide an insert and bead rubber composition for run-flat capability, which comprises syndiotactic 1,2-polybutadiene in place of the conventional reinforcing filler in order to allow only a small amount of filler to be filled in the tire, and to permit rubber products thereof to have a reduced weight and to be secured in strength of the insert and the bead.

It is yet another object of the present invention to provide the insert and bead rubber composition for the run-flat capability, which comprises syndiotactic 1,2-polybutadiene with a reduced amount of the reinforcing filler for the improvement of the run-flat capability of the run-flat tire such that the weight of rubber is decreased, whereby the rubber composition of the sidewall insert and bead is lowered in its weight, enhanced in tensile strength, fatigue resistance, crack resistance, and exothermic resistance at the same hardness and modulus, and prevents an increase in weight of the tire while satisfying run-flat endurance, thereby enhancing fuel efficiency of a vehicle.

In accordance with one aspect of the present invention, the above and other objects can be accomplished by the provision of a self-supporting type pneumatic run-flat tire comprising a tread, a sidewall and a bead, which is adapted to run stably at a constant velocity and a constant distance and capable of self-supporting a load of a vehicle upon reduction in internal pressure of the tire for standards of 60-series or less, characterized in that an insert rubber is located between an inner liner positioned inside the tire and carcasses constituting a frame of the tire, and a reinforcing sheet is located between the sidewall of the bead and an outermost carcass to enhance endurance of the bead contacting a rim flange when the run-flat tire runs on a road.

### BRIEF DESCRIPTION OF THE DRAWINGS

The foregoing and other objects and features of the present invention will be more clearly understood from the following detailed description taken in conjunction with the accompanying drawings, in which:

FIG. 1 is a cross-sectional view taken across a diameter of a self-supporting type pneumatic run-flat tire according to the present invention, illustrating one side of the normally expanded tire;

FIG. 2 is a cross-sectional view taken across the diameter of the tire similar to FIG. 1, illustrating a location of an insert rubber provided to a sidewall, a turn-up height (TUH) of a carcass, and a bead filler height (BFH) of a bead filler in the tire; and

FIG. 3 is a cross-sectional view taken across the diameter of the tire similar to FIG. 1, illustrating a gauge and a location of the insert rubber in the tire in accordance with the present invention.

### DETAILED DESCRIPTION OF THE INVENTION

In general the terms and phrases used herein have their art-recognized meaning, which can be found by reference to standard texts, journal references and contexts known to those skilled in the art.

Preferred embodiments of the present invention will be described in detail with reference to the accompanying drawings.

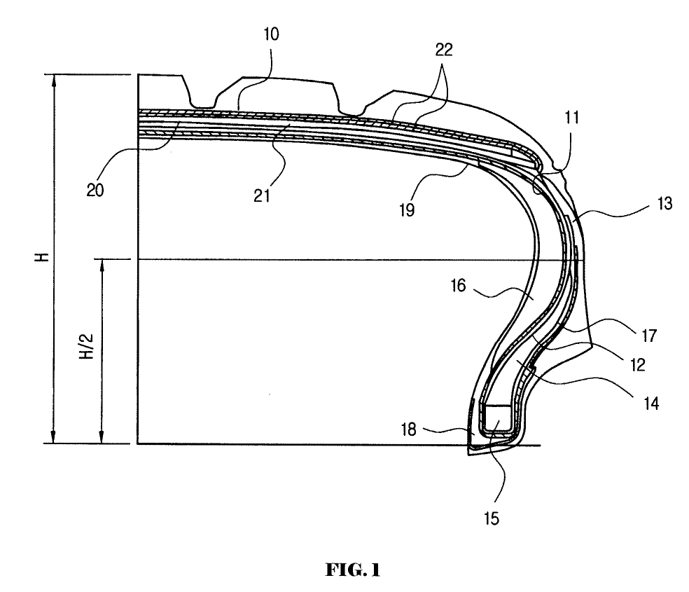

FIG. 1 is a cross-sectional view taken across a diameter of a self-supporting type pneumatic run-flat tire according to the present invention, illustrating one side of the normally expanded tire.

Referring to FIG. 1, the self-supporting type pneumatic run-flat tire according to the present invention comprises a tread 10 contacting a road, a sidewall 13 to protect first and second carcasses 11 and 12 from external impact, a bead filler 14 to regulate rigidity of the sidewall 13, a bead wire 15 to seat the tire on a rim, an insert rubber 16 provided to the sidewall 13 to secure run-flat capability, and a reinforcing sheet 17 for preventing rubber from being separated between the bead filler 14, first and second carcasses 11 and 12 and at the sidewall 13 at a bead contacting a rim flange upon running of the run flat tire.

Reference numerals 18, 19, 20, 21, and 22 denote chapper textile fabrics, an inner liner, a first belt layer, a second belt layer, and a reinforcing belt layer, respectively.

According to the present invention, in the run-flat tire having a height H in a cross section as shown in FIG. 1, the insert rubber 16 between the inner liner 19 and the first carcass 11 preferably has a thickest section located at about half of the height H of the tire, and is gradually decreased in thickness towards the belt layers 20 and 21, and towards the bead wire 15.

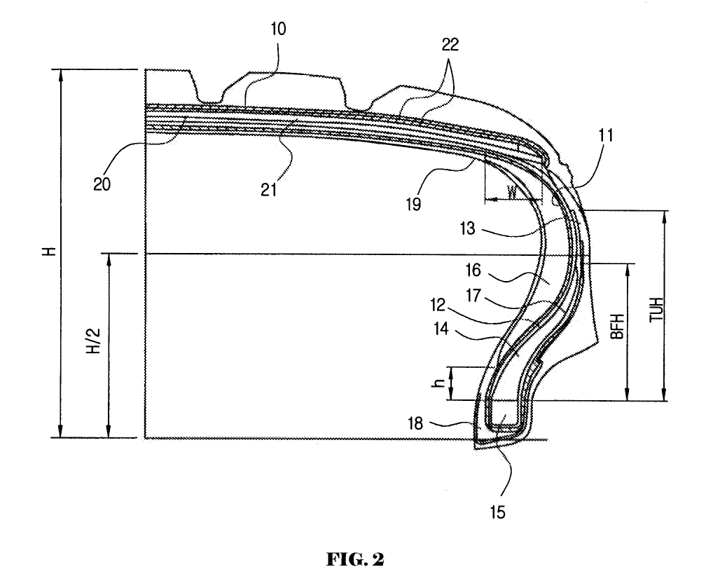

FIG. 2 is a cross-sectional view taken across the diameter of the tire similar to FIG. 1, illustrating a location of the insert rubber 16 provided to the sidewall, a turn-up height (TUH) of the carcass, a bead filler height (BFH) of the bead filler, and the like.

Referring to FIG. 2, according to the present invention, the insert rubber 16 used for securing the run-flat capability starts from its original point “h” spaced a distance of at least 5 mm or more from above the bead wire 15, and preferably spaced a distance in the range of 5 mm<h<20 mm from above the bead wire 15.

The insert rubber 16 extends to its end point “W” spaced a distance of at least 5 mm or more from the first belt layer 20, preferably spaced a distance in the range of 5 mm<W<25 mm from the first belt layer 20.

As shown in FIG. 2, for the pneumatic radial tire which employs one or more sheets of carcasses, it is preferable that a TUH (turn-up height) of the first carcass 11 is lower than the height H, but is higher than half of the height H. More preferably, the first carcass 11 has a TUH in the range of 50˜70 % of the height H. In addition, it is preferable that the TUH of the first carcass 11 is at least 10 mm higher than a BFH (bead filler height).

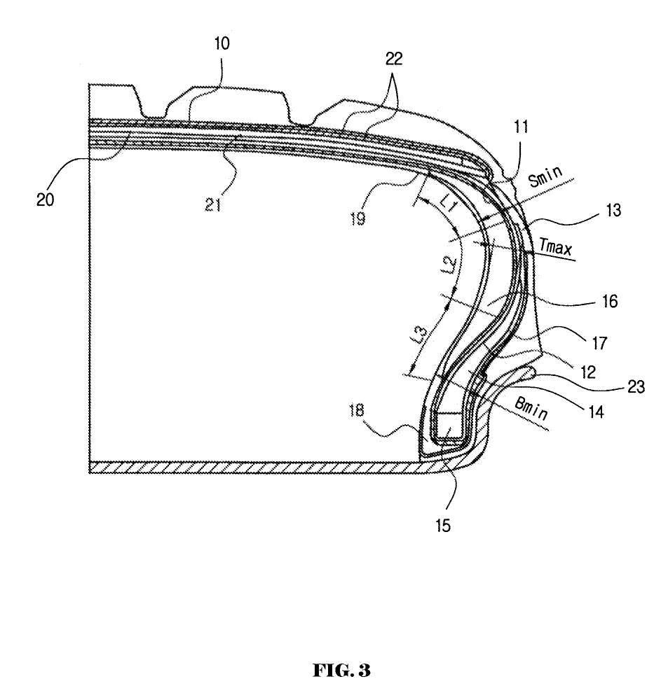

FIG. 3 is a cross-sectional view taken across the diameter of the tire similar to FIG. 1, illustrating a gauge and a location of the insert rubber 16 in the tire of the present invention.

When dividing the insert rubber 16 of the present invention into a first section L1, a second section L2, and a third section L3, the insert rubber 16 preferably has the maximum thickness, Tmax in the second section L2, so that the thickness of the first section L1 gradually thins towards the belt layers 20 and 21, and the thickness of the third section L3 also gradually thickness towards the bead wire 15.

Preferably, the insert rubber 16 is designed such that the minimum gauge Sₘᵢₙ of the whole sidewall is located at a border between the first section L1 and the second section L2, and similar to the minimum gauge Bₘᵢₙ of the whole bead in the bead contacting the rim flange 23. More preferably, a ratio of Sₘᵢₙ/Bₘᵢₙ is in the range of 0.9˜1.1.

The reinforcing sheet 17 is formed from a point spaced a distance of 5 mm or more from the bead wire to a point spaced a distance of 10 mm or more from above the bead filler in order to protect the bead when the run-flat tire runs on the road.

In accordance with the present invention, an insert and bead rubber composition is provided, which comprises: 20˜80 parts by weight of natural rubber as a raw rubber; 10˜80 parts by weight of polybutadiene with syndiotactic 1,2-polybutadiene well dispersed therein in place of the reinforcing filler; 20˜70 parts by weight of filler for the 0˜50 parts by weight of polybutadiene; 0.5˜6 parts by weight of sulfur as a vulcanizing agent; 0.5˜4 parts by weight of sulfenamide as a vulcanization accelerator; and 0.5˜5 parts by weight of a deterioration inhibitor in order to enhance the run-flat capability of the sidewall insert and bead rubber.

In the present invention, polybutadiene with syndiotactic 1,2-polybutadiene well dispersed therein preferably comprises 3˜35% of syndiotactic 1,2-polybutadiene.

The content of polybutadiene containing syndiotactic 1,2-polybutadiene is preferably in the range of 10˜80 parts by weight of the whole raw rubber. If the content of polybutadiene is less than 10 parts by weight, it is difficult to secure a desired modulus level since syndiotactic 1,2-polybutadiene does not sufficiently act as the reinforcing filler. On the contrary, if the content of polybutadiene is more than 80 parts by weight, there arise drawbacks such as reduction in workability of mixing and extrusion, in crack resistance, and in exothermic properties due to excessively high contents of butadiene and syndiotactic 1,2-polybutadiene.

In addition, if the content of syndiotactic 1,2-polybutadiene is less than 3%, it cannot act as the reinforcing filler, so that the rubber of the present invention does not exhibit a significant difference in its capability from that of a general butadiene rubber. On the contrary, if the content of syndiotactic 1,2-polybutadiene exceeds 35%, the modulus is rapidly increased, making it difficult to obtain a suitable run-flat capability. Thus, syndiotactic 1,2-polybutadiene is preferably in the range of 10˜20% in order to obtain the suitable run-flat capability.

In the insert and bead rubber composition of the present invention, syndiotactic polybutadiene is included in place of the reinforcing filler of the conventional rubber composition, thereby preventing an increase in weight due to the reinforcing filler, while ensuring the fatigue resistance, crack resistance, and exothermic resistance.

### EXAMPLES

Examples of the present invention are described hereinafter. In this regard, it should be noted that the examples of the present invention are provided only for an illustrative purpose, and do not limit the scope of the present invention.

### Examples 1 and 2

A rubber composition comprising a natural rubber (STR-20), polybutadiene (VCR617 available from UBEPOL) containing syndiotactic 1,2-polybutadiene, carbon black (GPF), zinc oxide (KS #2), stearic acid (curing agent, P60), anti-aging agent 1 (6PPD), anti-aging agent 2 (RD), sulfur (powder sulfur), a vulcanization accelerator (TBBS), deterioration inhibitor (KA9188 available from Bayer) according to the composition shown in Table 1, was vulcanized at a temperature of 160° C. for 20 minutes. On the basis of ASTM standards, vulcanized sheets were tested in order to measure tensile properties, Tan δ, fatigue resistance, crack resistance, exothermic resistance, specific gravity, results of which are listed in Table 2.

After producing run-flat tires comprising the rubber composition of the present invention, the tires were evaluated to confirm various capabilities, which are shown in Table 3. In the table, the endurance of each run-flat tire is expressed by an order of magnitude converted from a period of time until the tire fails to function normally after the tire is assembled to a rim, maintained for 24 hours at a temperature of 38° C. with an internal pressure of 2.5 kg/cm², adjusted in the internal pressure to atmospheric pressure by removing a valve, and started to run on a drum (a diameter of 1.7 m) at a velocity of 80 km/h with a load of 400 kg. In Table 3, the order of magnitude of Example 1 is expressed by 100 as a control. Rotation resistance of each Example was obtained according to Coast Down Test (SAE J2452) after assembling the tire to the rim, and the order of magnitude of each Example is expressed by 100 as a control.

### Comparative Examples 1 to 3

After preparing a rubber composition which was formed by mixing various additives according to the composition shown in Table 1, except that a butadiene rubber (KBR01 available from Kumho Petrochemical Co.) was used instead of polybutadiene containing syndiotactic 1,2-polybutadiene, the rubber composition was vulcanized at a temperature of 160° C. for 20 minutes. On the basis of ASTM standards, vulcanized sheets were tested in order to measure tensile properties, Tan δ, fatigue resistance, crack resistance, exothermic resistance, specific gravity, results of which are listed in Table 2.

After producing run-flat tires comprising the rubber composition of Comparative Examples 1 and 3, the tires were evaluated to confirm various capabilities, which are shown in Table 3. In the table, the endurance of each run-flat tire is expressed by an order of magnitude converted from a period of time until the tire fails to function normally after the tire is assembled to a rim, maintained for 24 hours at a temperature of 38° C. with an internal pressure of 2.5 kg/cm², adjusted in the internal pressure to atmospheric pressure by removing a valve, and started to run on a drum (a diameter of 1.7 m) at a velocity of 80 km/h with a load of 400 kg. In Table 3, the order of magnitude of Example 1 is expressed by 100 as a control. Rotation resistance of each Example was obtained according to Coast Down Test (SAE J2452) after assembling the tire to the rim, and the order of magnitude of Example 1 is expressed by 100 as a control.

TABLE 1

| | | | Compar- | Compar- | Compar- |
|---|---|---|---|---|---|
| | | Exam- | ative | ative | ative |
| Composition | Example 1 | ple 2 | Example 1 | Example 2 | Example 3 |
| Natural | 30 | 30 | 30 | 30 | 30 |
| rubber | | | | | |
| polybutadiene | 70 | 50 | | | |
| containing | | | | | |
| syndiotactic | | | | | |
| 1,2- | | | | | |
| polybutadiene | | | | | |
| Butadiene | | 20 | 70 | 70 | 70 |
| rubber | | | | | |
| Carbon black | 45 | 55 | 45 | 65 | 65 |
| Zinc oxide | 5 | 5 | <— | <— | <— |
| Stearic acid | 2 | 2 | <— | <— | <— |
| Anti-aging | 1.5 | 1.5 | <— | <— | <— |
| agent 1 | | | | | |
| Anti-aging | 1.5 | 1.5 | <— | <— | <— |
| agent 2 | | | | | |
| Sulfur | 3.0 | 3.0 | <— | <— | 3.0 |
| Vulcanization | 1.5 | 1.5 | <— | <— | 2.0 |
| accelerator | | | | | |
| Deterioration | 1.0 | 1.0 | <— | <— | 1.0 |
| inhibitor | | | | | |

(Unit: part by weight)

TABLE 2

| | | | | Comparative | Comparative | Comparative |
|---|---|---|---|---|---|---|
| | | Example 1 | Example 2 | Example 1 | Example 2 | Example 3 |
| Tensile | Hardness | 75 | 75 | 65 | 71 | 74 |
| properties | Modulus | 75 | 77 | 40 | 65 | 73 |
| | Elongation | 190 | 200 | 200 | 150 | 120 |
| | Tensile | 160 | 155 | 145 | 120 | 110 |
| | strength | | | | | |
| Fatigue | Life cycle | 6000 | 5000 | 6000 | 1500 | 500 |
| resistance | | | | | | |
| Crack | Growth | 0.4 | 0.4 | 0.4 | 1.0 | 2.0 |
| resistance | rate | | | | | |
| Tan δ | At 80° C. | 0.04 | 0.04 | 0.04 | 0.08 | 0.07 |
| Specific | g/cc | 1.34 | 1.35 | 1.35 | 1.41 | 1.41 |
| gravity | | | | | | |

TABLE 3

| | | | Exam- | Comparative | Comparative |
|---|---|---|---|---|---|
| | | Example 1 | ple 2 | Example 1 | Example 2 |
| Run-flat | Order of | 100 | 100 | 10 | 30 |
| endurance | magnitude | | | | |
| Rotation | Order of | 100 | 90 | 95 | 95 |
| resistance | magnitude | | | | |

As apparent from the above description, according to the present invention, the run-flat tire comprises syndiotactic 1,2-polybutadiene with a reduced amount of the reinforcing filler for the purpose of enhancing the run-flat capability such that the weight of rubber is decreased, whereby the tensile strength, fatigue resistance, crack resistance, and exothermic resistance of the run-flat tire are increased at the same hardness and modulus.

In addition, according to the present invention, the run-flat tire is prevented from being increased in weight while satisfying the run-flat endurance property, thereby enhancing fuel efficiency of a vehicle.

It should be understood that the embodiments and the accompanying drawings as described above have been described for illustrative purposes and the present invention is limited by the following claims. Further, those skilled in the art will appreciate that various modifications, additions and substitutions are allowed without departing from the scope and spirit of the invention as set forth in the accompanying claims.

Every formulation or combination of components described or exemplified herein can be used to practice the invention, unless otherwise stated.

Whenever a range is given in the specification, for example, a temperature range, a time range, or a composition or concentration range, all intermediate ranges and subranges, as well as all individual values included in the ranges given are intended to be included in the disclosure.

All patents and publications mentioned in the specification are indicative of the levels of skill of those skilled in the art to which the invention pertains. References cited herein are incorporated by reference herein in their entirety to indicate the state of the art as of their filing date and it is intended that this information can be employed herein, if needed, to exclude specific embodiments that are in the prior art.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, reagents, solid substrates, synthetic methods, purification methods, and analytical methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

All references cited herein are hereby incorporated by reference to the extent that there is no inconsistency with the disclosure of this specification. Some references provided herein are incorporated by reference to provide details concerning sources of starting materials, additional starting materials, additional reagents, additional methods of synthesis, additional methods of analysis and additional uses of the invention.

We claim:

1. A self-supporting type pneumatic run-flat tire comprising a tread, a sidewall and a bead, which are adapted to run stably at a constant velocity and a constant distance and capable of self-supporting a load of a vehicle upon reduction in internal pressure of the tire for standards of 60-series or less, characterized in that,
an insert rubber is located between an inner liner positioned inside the tire and a carcass constituting a frame of the tire, and a reinforcing sheet is located between the sidewall of the bead and an outermost carcass to enhance endurance of the bead contacting a rim flange when the run-flat tire runs on a road.

2. The run-flat tire according to claim 1, wherein an original point “h” of the insert rubber is set in the range of 5 mm˜20 mm from above the bead wire.

3. The run-flat tire according to claim 1, wherein an end point “W” of the insert rubber is set in the range of 5 mm˜25 mm from the first belt layer.

4. The run-flat tire according to claim 1, wherein, when dividing the insert rubber into a first section L1, a second section L2, and a third section L3, the insert rubber has a maximum gauge Tmax located in the second section L2.

5. The run-flat tire according to claim 1, wherein, when dividing the insert rubber into a first section L1, a second section L2, and a third section L3, the whole sidewall has a minimum gauge Sₘᵢₙ located at a border between the first section L1 and the second section L2.

6. The run-flat tire according to claim 5, wherein the minimum gauge Sₘᵢₙ of the whole sidewall is similar to the minimum gauge Bₘᵢₙ of the whole bead in the bead contacting the rim flange.

7. The run-flat tire according to claim 6, wherein a ratio of the minimum gauge Sₘᵢₙ of the whole sidewall to the minimum gauge Bₘᵢₙ of the whole bead is in the range of 0.9˜1.1.

8. An insert and bead rubber composition, comprising a natural rubber as a raw rubber, a polybutadiene rubber, filler, a vulcanizing agent, a vulcanization accelerator, and a deterioration inhibitor for run-flat capability, characterized in that
the natural rubber as the raw rubber is in the range of 20˜80 parts by weight, polybutadiene with a syndiotactic 1,2-polybutadience well dispersed therein is in the range of 10˜80 parts by weight, and the polybutadiene rubber is in the range of 0˜50 parts by weight.

9. The rubber composition according to claim 8, wherein the polybutadiene with a syndiotactic 1,2-polybutadiene well dispersed therein comprises 3˜35 % of syndiotactic 1,2-polybutadiene.
